(19) United States
(12) Patent Application Publication
(10) Pub. No.: US 2025/0096850 A1
(43) Pub. Date: Mar. 20, 2025

(54) SIGNALING SCHEMES FOR RECONFIGURABLE INTELLIGENT SURFACES IN WIRELESS COMMUNICATIONS

(71) Applicant: ZTE Corporation, Shenzhen (CN)

(72) Inventor: Ruiqi LIU, Shenzhen (CN)

(21) Appl. No.: 18/727,211

(22) PCT Filed: Jan. 6, 2022
(86) PCT No.: PCT/CN2022/070413

§ 371 Date: Jul. 8, 2024

(51) Int. Cl. H04B 7/04; H04B 7/06; H04W 24/10

(52) U.S. Cl. CPC H04B 7/04013; H04B 7/06952; H04W 24/10

(57) ABSTRACT

Techniques are described for signaling in environments including one or more reconfigurable intelligent surfaces (RISs). An example wireless communication method includes transmitting, from a network device, a first signal to a subset of reflective elements of a surface comprising a plurality of reflective elements, the first signal being reflected off the surface in at least a first direction toward a wireless device. The method further includes receiving, from the wireless device, a second signal based on the first signal. For example, the first signal can include a reference signal, and the second signal can include a measurement of the reference signal. Based on the signaling, the subset, a different subset, or no subset of reflective elements can be selected for transmission.

### TECHNICAL FIELD This disclosure is directed generally to wireless communications.

### BACKGROUND

Mobile telecommunication technologies are moving the world toward an increasingly connected and networked society. The rapid growth of wireless communications and advances in technology has led to greater demand for capacity and connectivity. Other aspects, such as energy consumption, device cost, spectral efficiency, and latency can also be important to meeting the needs of various communication scenarios. In comparison with the existing wireless networks, next generation systems and wireless communication techniques will need to support an increased number of users and devices in a wide range of use-cases and environments.

### SUMMARY

Techniques are disclosed for signaling schemes in environments including one or more Reconfigurable Intelligent Surfaces (RISs).

In one exemplary aspect, a wireless communication method is disclosed. The method includes transmitting, from a network device, a first signal to a subset of reflective elements of a surface comprising a plurality of reflective elements, the first signal being reflected off the surface in at least a first direction toward a wireless device; and receiving, from the wireless device, a second signal based on the first signal.

In another exemplary aspect, a wireless communication method is disclosed. The method includes receiving, at a wireless device, a first signal in a first direction, wherein the first signal is reflected off a subset of reflective elements of a surface comprising a plurality of reflective elements; and transmitting a second signal to a network device or the surface based on the first signal.

In another exemplary aspect, a wireless communication method is disclosed. The method includes transmitting a signal indicative of availability of a surface for reflecting transmissions, the surface including a plurality of reflective elements.

In another exemplary aspect, a wireless communication method is disclosed. The method includes receiving a signal indicative of availability of a surface for reflecting transmissions, the surface including a plurality of reflective elements; and transmitting a message based on the received signal.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example of a reconfigurable intelligent surface (RIS).

FIG. 2 shows another example of an RIS.

FIG. 3 shows an example of wireless communication including a base station (BS), an RIS, and user equipment (UE).

FIG. 4 shows a flowchart of an example method of wireless communication.

FIG. 5 shows a flowchart of an example method of wireless communication.

FIG. 6 shows an example of wireless communication including a BS, an RIS, and a UE.

FIG. 7 shows a flowchart of an example method of wireless communication.

FIG. 8 shows a flowchart of an example method of wireless communication.

FIGS. 9A-B show examples of wireless communication including a BS, a plurality of RISs, and a plurality of UEs.

FIG. 10 is a block diagram representation of a portion of an apparatus that can be used to implement methods and/or techniques of the presently disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G or 6G terminology is used for the sake of clarity of explanation, but the techniques disclosed in the present document are not limited to 5G or 6G technology only, and may be used in wireless systems that implement other protocols.

### Introduction

A reconfigurable intelligent surface (RIS), also referred to as an “intelligent reflecting surfaces (IRS) or “large intelligent surface” (LIS), comprises an array of RIS units, also referred to as “elements” or “reflective elements.” Each unit can independently incur some change to the incident signal. Such changes can include changing the angle, phase, amplitude, frequency, or polarization of an incident signal. These properties can be tuned by adjusting electromagnetic properties of the units. For changes in which the incident signal only experiences a phase shift upon reflection, the RIS consumes no power, and is hence passive. An RIS can be deployed strategically to intelligently configure a wireless environment to better facilitate transmissions between a sender and receiver, such as when direct communication is not possible. For example, RISs can be deployed on walls, building facades, ceilings, or billboards to reflect signals around obstacles while simultaneously optimizing their properties. The ability of RISs to tune the wireless environment makes them promising for use in 6G communications networks.

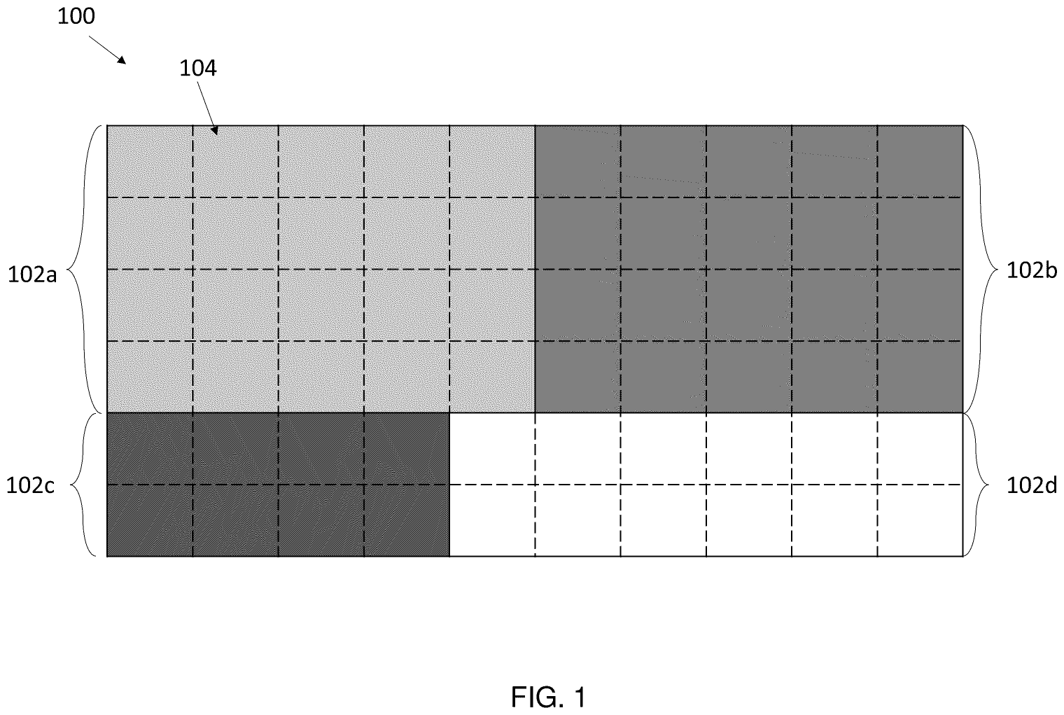

FIG. 1 shows an example of a reconfigurable intelligent surface (RIS) 100. The RIS 100 can be divided into sub-panels 102a-d, where each sub-panel 102a-d can comprise one or more reflective elements 104 and can serve different users. For instance, the RIS 100 can have 100*100=10,000 reflective elements on it. For illustrative purposes, RIS 100 is shown with 10*6 reflective elements. A rectangular RIS 100 can generally have N*M reflective elements, where N and M are positive integers, though the RIS 100 can comprise non-rectangular arrays of units. In addition, the RIS 100 depicted with four subpanels, though other numbers of subpanels can be configured. In general, each subpanel 102a-d can comprise a subset of the total set of reflective elements of the RIS 100. In some embodiments, each subpanel 102a-d can comprise a contiguous subset of reflective elements, such as a rectangular or non-rectangular array. Each subpanel can be configured to serve a different UE, or various combinations of the subpanels can serve a same UE.

The RIS 100 can include a RIS controller that configures the properties of the reflective elements. In some embodiments, the RIS controller can receive or transmit control signaling, through wired or wireless channels. In some embodiments, the RIS controller can be controlled by a network node or a base station (BS), for example if a network provider installs the RIS 100 in the environment. In some embodiments, the RIS controller 102 can be a user equipment (UE) or a stand-alone device.

Dividing the RIS 100 into sub-panels can better enable the RIS 100 to serve multiple UEs. When there is only one UE that needs to be served by the RIS 100, all the elements can be used to serve that UE to provide better signal strength. In general, more elements used for reflection can result in proportionally greater reflected energy. If the RIS 100 serves two UEs, then the RIS can be divided into 2 sub-panels, each with a smaller number of reflective elements. If the RIS 100 serves N>2 UEs, then a greater number of sub-panels can be used. Note that there not necessarily be N sub-panels, since some UEs may be close to each other and can be served by the same sub-panel.

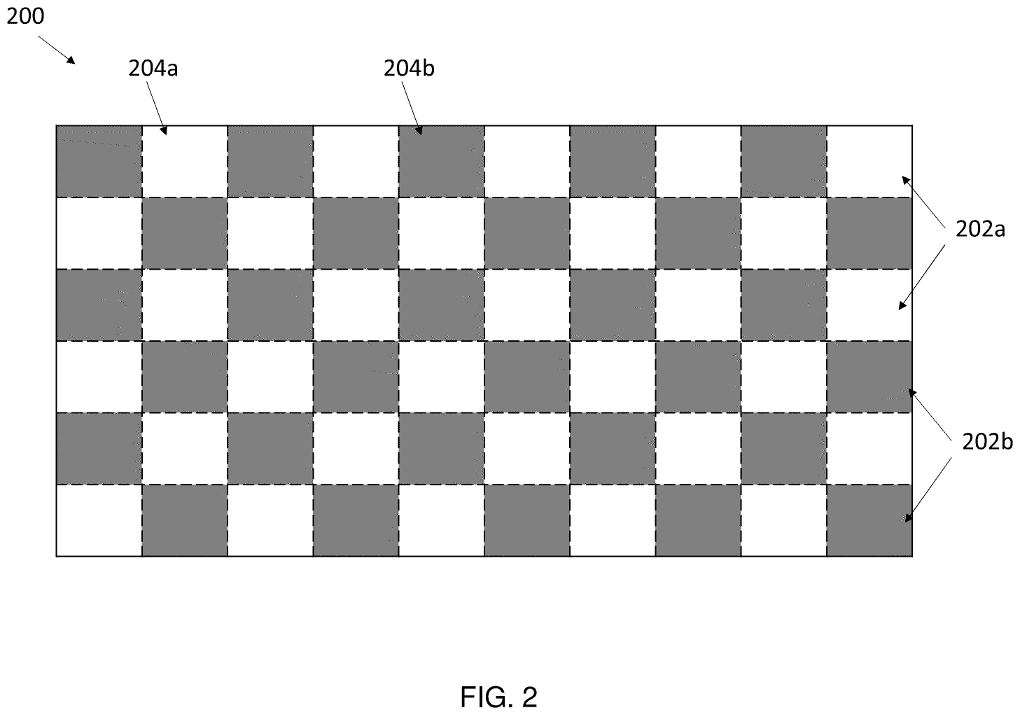

FIG. 2 shows another example of an RIS 200 including a plurality of subpanels. A subpanel can be thought of as a logical or virtual concept, and does not have to be an area on the RIS 200 where all elements are adjacent to each other. As shown in FIG. 2, a subpanel can comprise a non-contiguous set of reflective element. For example, all the elements 204a can comprise a first subpanel 202a, while the elements 204b can comprise a second subpanel 202b . Essentially, a subpanel can be generalized as a group of reflective elements which is a subset of all the reflective elements of the RIS 200, combined with a coefficient matrix applied to the elements. Thus, the reflective elements of a subpanel can be adjacent to each other or even randomly distributed. In some embodiments, multiple subpanels can share reflective elements. Even with a same set of physical elements, if the co-efficient matrix applied on those elements are different, they can be part of different sub-panels.

In some embodiments, the coefficient matrix can include values for controlling the phase shift for each RIS element. This coefficient matrix can be referred to as a “phase shift matrix,” among other names.

Currently, 5G New Radio (NR) networks include a concept of candidate beams in higher frequencies, e.g., FR2. Candidate beams address the issue when one beam used by a BS and a UE is blocked, enabling the UE to quickly switch to the candidate beam so that the link can be reestablished more quickly compared to prior methods of reestablishment. Embodiments of the present disclosure address similar issues, but applied to scenarios involving RISs, which present their own unique challenges.

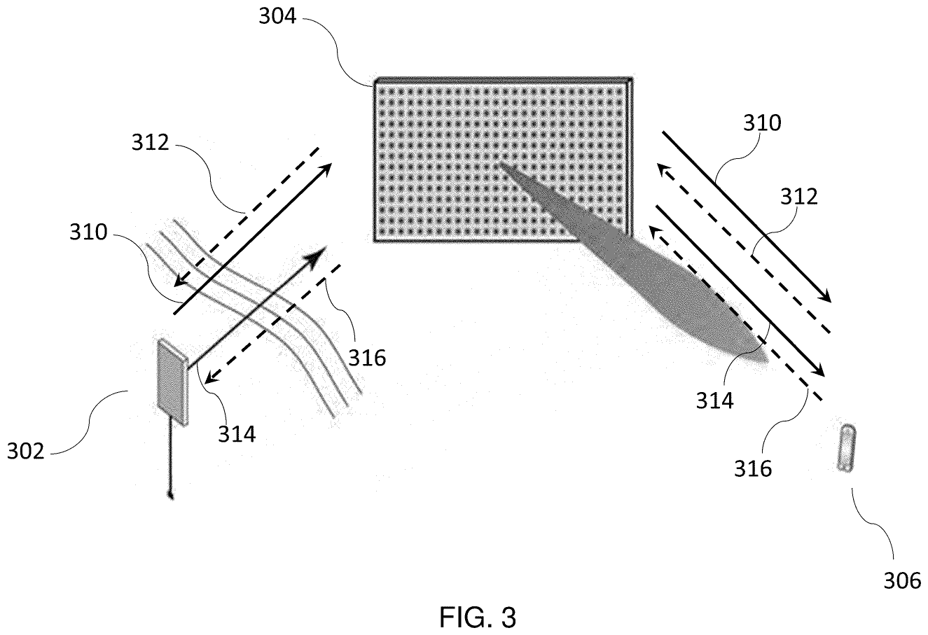

FIG. 3 shows an example of wireless communication including a base station (BS) 302, an RIS 304, and user equipment (UE) 306. In this example, a BS 302—RIS 304—UE 306 link is established. The RIS 304 can include a controller (not pictured) that can configure the reflective elements of the RIS 304. In one example scenario, the UE 306 can first be served by a first subpanel of the RIS 304. Then it can be determined that the a second subpanel of the RIS 304 should be used to serve the UE 306. For example, if additional UEs need to be served by the RIS 304, then it may be preferable to serve those UEs using the first subpanel. In other examples, there can be a decreased number of users served, or certain elements need to be reserved for other purposes. In this case, if the RIS 304 directly switches from the first subpanel 1 to the second subpanel without informing the UE 306, then the UE 306 can experience a change in channel conditions, such as Channel Status Information (CSI), received power level, etc. The change in channel condition can negatively affect the UE 306. For example, a drastic change on channel conditions can cause the link to be severed, or the UE 306 may need to perform automatic gain control (AGC) settling when received power changes significantly. Therefore, embodiments of the present disclosure employ signaling that can be used to avoid such negative effects.

In addition, the UE 306 or BS 302 can monitor certain criteria to determine a quality of the communication link, such as signal-to-interference-plus-noise ratio (SINR), Reference Signal Received Power (RSRP), or Reference Signal Received Quality (RSRQ). If a link, such as the link shown in FIG. 3, fades out gradually, the BS 302 or the UE 306 can determine that a switch to a candidate link is needed, which can involve the change of subpanel. Therefore, embodiments of the present disclosure also relate to supporting this functionality.

### Training Process and Candidate Subpanels

Referring to FIG. 3 as an example, a training process can be implemented to enable the BS 302 or the UE 306 to determine an optimal subpanel to use for transmitting or receiving signals. In addition, the training process can enable the BS 302 a or the UE 306 to select one or more candidate subpanels. In some embodiments, the training process can allow the BS 302 or the UE 306 to determine one or more candidate beams. During the training process, a first signal 310 can be transmitted from the BS 302 to the RIS 304, which is then reflected to the UE 306 using a subpanel of the RIS 304. For example, the first signal 310 can be a pilot signal or include a reference signal. A second signal 314, for example including a second reference signal, can be transmitted from the BS 302 to the RIS 304 and reflected by a second subpanel to UE 306. The UE 306 can transmit one or more return signals, such as return signals 312 and 316. For example, these return signals 312 and 316 can include measurement results corresponding to reference signals included in signals 310 and 314, respectively. In some embodiments, the return signals 312 and 316 can be reflected off the RIS 304. In other embodiments, return signals 312 or 316 can be transmitted directly to the BS 302, or reflected off a different RIS. Based on these return signals 312 or 316, the BS 302 can determine an optimal subpanel for transmission. For example, the BS 302 can select the subpanel corresponding to a stronger measurement result. The UE 306 can select an optimal or candidate subpanel in a similar manner. For example, the UE 306 can select a subpanel by associating subpanels with directions of received reference signals, and select a direction based on a measurement result of the reference signals. This process can be repeated multiple times with additional signals that are reflected off additional subpanels of the RIS 304, allowing the BS 302 and/or the UE 306 determine the current optimal beam and subpanels to use, or one or more candidate beams or subpanels.

To maintain a set of candidate subpanels or to make sure a candidate subpanel or beam association is still valid, measurements on reference signals can be conducted periodically. For example, if a current candidate subpanel is not valid, a new candidate subpanel can be determined using these periodic measurements. In some embodiments, measurements can be performed non-periodically, such as in response to certain conditions. Whether periodic or not, the measurements can be configured by the network. In some embodiments, the UE 306 can configure periodic measurements, for example by transmitting an uplink reference signal. In this manner, measurement results can be used to maintain or update candidate subpanels.

In some embodiments, a subpanel may be invalid. For example, if the UE 306 is moving at a high speed, this can affect channel conditions. If the UE 306 is unable to transmit a signal to the BS 302 or perform a measurement, then the BS 302 can determine that the subpanel is invalid and select a different candidate subpanel.

In some embodiments the UE 306 can maintain a set of candidate beams without maintaining a set of candidate subpanel, while the network can handle associations between beams and subpanels. In this case, it may not be necessary for subpanels to be visible to UEs. In some embodiments, there may be no candidate beams, such as in current FR1 implementations. In this case, the UE 306 can maintain a set of candidate subpanels as described above.

In some embodiments, the techniques described above do not need to include the BS 306. For example, candidate subpanels or beams can be determined between UEs, such as in a UE to UE sidelink.

In some embodiments, a change of subpanel can be triggered by certain measurement results on certain reference signals. For example, a BS can monitor SINR, RSRP, RSRQ, or other reference signals and determine that a change to a candidate sub-panel should be performed, e.g., for a better-quality link.

In some embodiments, the signaling can indicate that the RIS 304 is unavailable. In this case, the RIS 304 will not use any element to serve the UE 306 or BS 302, and candidate subpanels can be updated accordingly.

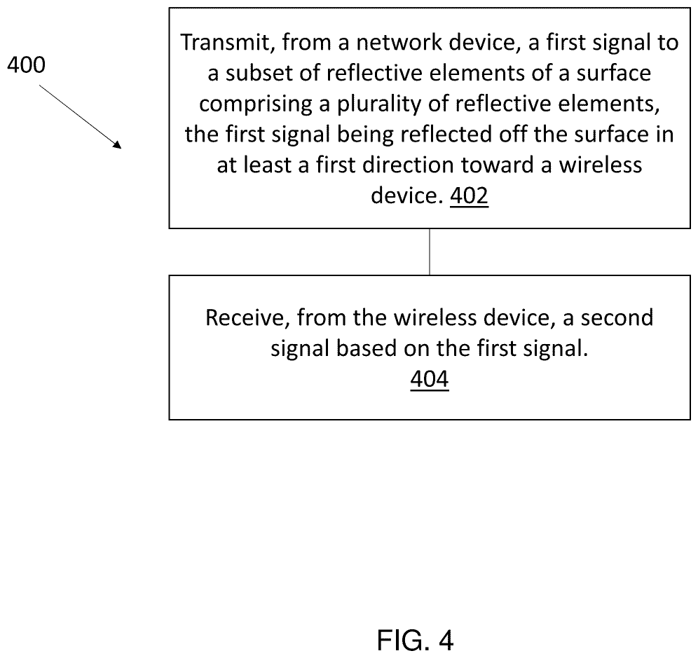

FIG. 4 shows a flowchart of an example method 400 of wireless communication. At 402, a first signal is transmitted from a network device to a subset of reflective elements of a surface comprising a plurality of reflective elements, the first signal being reflected off the surface in at least a first direction toward a wireless device. At 404, a second signal based on the first signal is received from the wireless device. In some embodiments, the first signal includes a reference signal, and the second signal includes a measurement result of the reference signal. The network device can modify a configuration based on the received second signal, such as selecting a subset of reflective elements for transmission. In some embodiments, the first signal can be associated with a beam.

In some embodiments, the method 400 can further include transmitting a third signal to a second subset of the reflective elements of the surface, the third signal being reflected off the surface in at least a second direction toward the wireless device, and receiving a fourth signal from the wireless device. The method 400 can further include transmitting and receiving additional signals, such as part of a training process.

In some embodiments, the surface comprising a plurality of reflective elements can be a RIS. The surface and the reflective elements can be configured by a controller coupled to the surface. The controller can be configured by signaling from a network, such as from a BS or network node. In some embodiments, the surface can comprise a rectangular array. The surface can also comprise a non-rectangular array. In some embodiments, subsets of the reflective elements can comprise contiguous elements. Subsets of the reflective elements can also comprise non-contiguous elements.

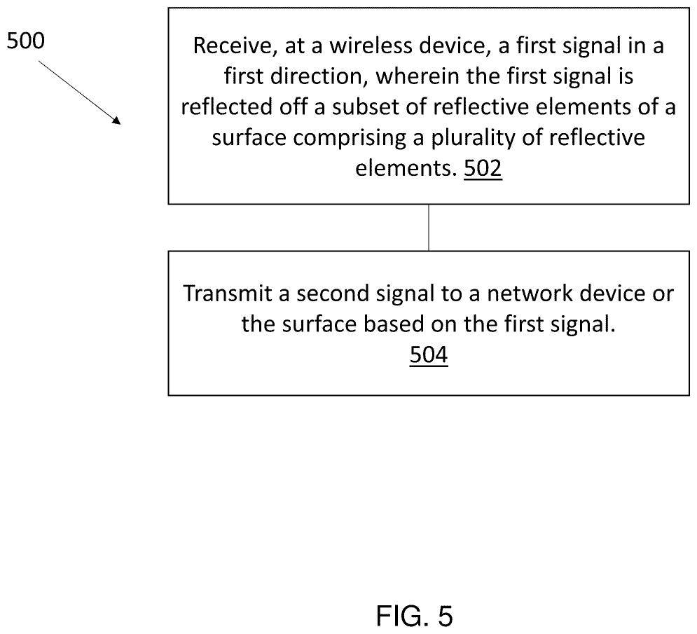

FIG. 5 shows a flowchart of an example method 500 of wireless communication. At 502, a first signal is received in a first direction at a wireless device, wherein the first signal is reflected off a subset of reflective elements of a surface comprising a plurality of reflective elements. At 504, a second signal is transmitted to a network device or the surface based on the first signal. In some embodiments, the first signal includes a reference signal, and the second signal includes a measurement result of the reference signal. The wireless device can modify a configuration based on the first signal, such as selecting a direction for receiving signals or selecting a subset of reflective elements for transmission. In some embodiments, the first signal can be associated with a beam.

In some embodiments, the method 500 can further include receiving, at the wireless device, a third signal in a second direction, wherein the third signal is at least partially reflected off a second subset of reflective elements of the surface and transmitting a fourth signal from the wireless device. The method 500 can further include receiving and transmitting additional signals, such as part of a training process.

In some embodiments, the surface comprising a plurality of reflective elements can be a RIS. The surface and the reflective elements can be configured by a controller coupled to the surface. The controller can be configured by signaling from a network, such as from a BS or network node. In some embodiments, the surface can comprise a rectangular array. The surface can also comprise a non-rectangular array. In some embodiments, subsets of the reflective elements can comprise contiguous elements. Subsets of the reflective elements can also comprise non-contiguous elements.

### RIS Controller Signaling

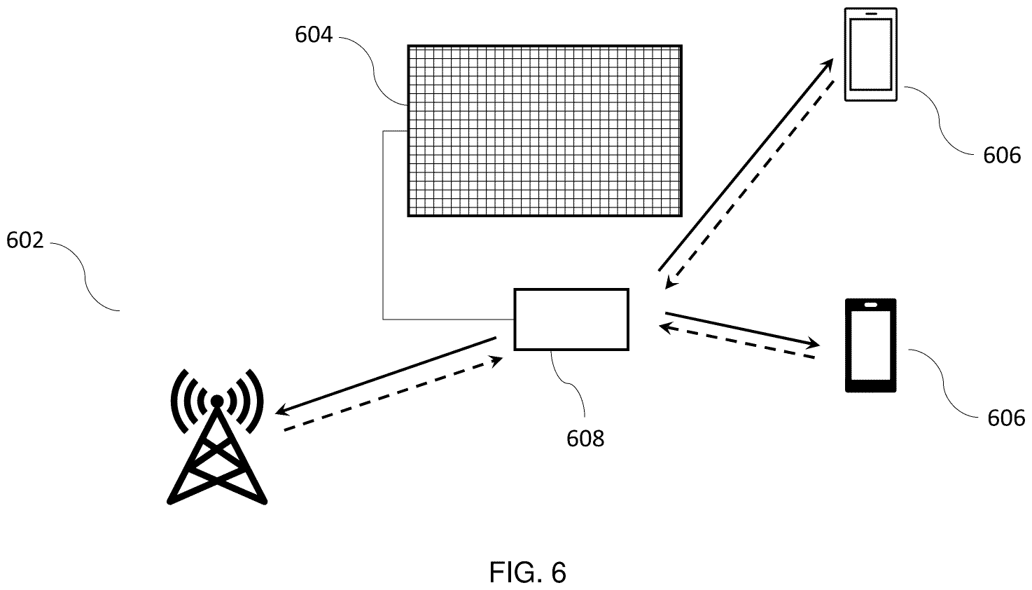

FIG. 6 shows an example of wireless communication including a base station (BS) 602, an RIS 604, and user equipment (UE) 606. Although only one BS 602, one RIS 604, and two UEs 606 are shown for illustration, the techniques described in this document can apply to other numbers of BSs, RISs, or UEs. The RIS 604 can be coupled to a controller 608 that can configure the reflective elements of the RIS 604.

In some embodiments, the controller 608 can transmit and receive signals, such as from or to the BS 602 or UEs 606. Signaling from the RIS controller 608 can inform the network, BS 602, or a UE 606 whether a subpanel or group of subpanels is available for reflecting or tuning transmissions. In response to the signaling, the network, BS, or UE can then trigger a change of subpanels. In some embodiments, the controller 608 can transmit and receive wireless signals, as shown in FIG. 6. In some embodiments, the controller 608 may be configured as a lower power device without a radio frequency (RF) component. In this case, the controller 608 can transmit and receive signaling through a wired connection, such as with another BS or network device, which then transmits and receives wireless signaling from the BS 602 or UEs 606

In some embodiments, the controller 608 can be configured by the network, while in other embodiments, the controller can be a stand-alone controller independent of the network. A stand-alone controller 608 needs to be able to allocate resources, such as the reflective elements or subpanels, to different devices and for different purposes. In addition, it is desired for the controller 608 manage the resources dynamically, either in response to receiving control signals or independently, and to inform the network, BS 602, or UE 606 regarding changes in configurations or availability of sub-panels. Thus, signaling schemes are needed in cases where the RIS controller is not configured by the network. For a RIS controller that is configured by the network, it is still advantageous to have signaling schemes to inform devices, such as UEs about subpanel configurations.

For example, in some embodiments, the RIS 604 is not controlled by the network. The RIS 604 can serve a BS 602 and UEs 606. The RIS controller 608 may need to change the subpanel currently serving a UE 606. In such a case, the RIS controller 608 can inform the UE 606 alone or both the UE 606 and the network, for example by transmitting a signal to a network node. The signaling can indicate when the change of subpanel will be applied, such as indicating a time interval. In addition, the signaling can indicate a new subpanel configuration, for example indicating a coefficient matrix of a subpanel. The signaling can also indicate suggested transmission or reception parameters for the BS 602 or the UE 606.

In some embodiments, the RIS controller 608 can transmit signaling to the BS 602, UEs 606, or a network node to indicate a current availability of reflective elements or subpanels. For example, the signaling can include at least one of the following information:
A total number of elements on the X-axis;
A total number of elements on the Y-axis;
An available number of areas or sub-panels; or {X_start_i, X_end_i, Y_start_i, Y_end_i}, where X_start_i refers to a starting point of the ith available area on the X-axis, X_end_i refers to an end point of the ith available area on the X-axis, Y_start_i refers to a starting point of the ith available area on the Y-axis, and Y_end_i refers to an end point of the ith available area on Y-axis; or
A status of an available area.

For example, the status can indicate whether the area is currently reserved, reserved but available for a short time, available and not reserved, or other statuses. In some embodiments, an indication that an area or subpanel is reserved can also indicate a device that is associated with the reservation, such as a BS or UE. Indicating which BS or UE a subpanel is reserved for can help facilitate joint optimization. A “reserved” indication can also indicate a time that a reserved subpanel is reserved for, or indicate a purpose associated with the reservation. For example, possible purposes can include at least one of: facilitating communication, emergency use, facilitating sensing, or facilitating positioning.

In some embodiments, the RIS controller 608 can indicate a set of IDs of reflective elements of one or more subpanels of the RIS 608. For example, the signaling may include indices associated with the reflective elements. For instance, for a subpanel comprising non-contiguous reflective elements, one such signaling may indicate {1, 3, 5, 7, . . . }. Such as signaling can be used for an RIS 604 that is non-rectangular.

In some embodiments, a BS 602 or UE 606 an transmit a message indicating a request for availability to the RIS controller 608. For example, the BS 602 or the UE 606 can request availability of a certain area or subpanel of the RIS 604. The RIS controller 608 can send feedback indicating at least one of: 1) a successful request; 2) an unsuccessful request, e.g., due to unavailability of an area; or 3) a recommended area or subpanel to be used. The UE 606 or the BS 602 can request a size of an area, such as 20*20 elements. Alternatively, or additionally, the request can indicate a position of the area on the RIS 604, such as starting coordinate. In some embodiments, the RIS controller 608 can indicate in a feedback message that the all elements or subpanels of the RIS 604 are unavailable.

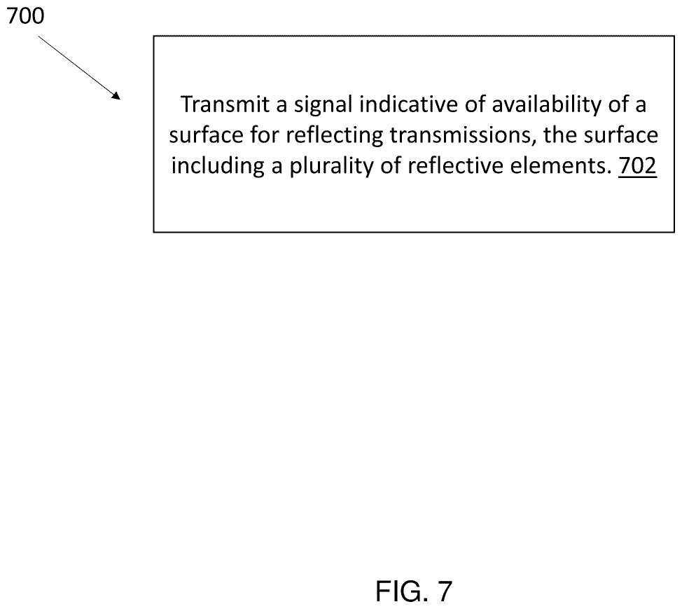

FIG. 7 shows a flowchart of an example method 700 for wireless communication. At 702, a signal indicative of availability of a surface for reflecting transmissions is transmitted, the surface including a plurality of reflective elements. For example, the signal can be transmitted from a controller of the surface, and the surface can be a RIS, similar to RIS controller 608 and RIS 604 of FIG. 6. The controller can be configured by signaling from a network, such as from a BS or network node. In some embodiments, the surface can comprise a rectangular array. The surface can also comprise a non-rectangular array. In some embodiments, subsets of the reflective elements can comprise contiguous elements. Subsets of the reflective elements can also comprise non-contiguous elements.

In some embodiments, the method can further include receiving a request for availability of a specified subset of the plurality of reflective elements, wherein the signal includes at least one of: an indication the specified subset is available; an indication the specified subset is unavailable; or the indication the specified subset is unavailable and a suggested available subset. In some embodiments, the request can indicate a size of the specified subset or a coordinate of the specified subset. The request can be received from a network device or a wireless device, including a BS or UE.

In some embodiments the signal at step 702 can indicate a subset of the plurality of reflective elements is available. In this case, the method 700 can further include reflecting a message off the subset of the plurality of reflective elements. The signal can include at least one of: an indication of a time a change in availability is applied; a coefficient matrix; or transmission or receiving parameters associated with the configuration. Alternatively or additionally, the signal can include at least one of: a number of available subsets of the plurality of reflective elements; a status of an available subset of the plurality of reflective elements; coordinates of the available subset; scheduling information of the available subset; or an indication of a purpose associated with the available subset. The purpose associated with the available subset can be one of: facilitating communication; facilitating sensing; facilitating positioning; or emergency use.

In some embodiments, the signal at step 702 can include an indication that a subset of the plurality of reflective elements is unavailable. In this case, the signal can include information identifying a device currently associated with the unavailable subset.

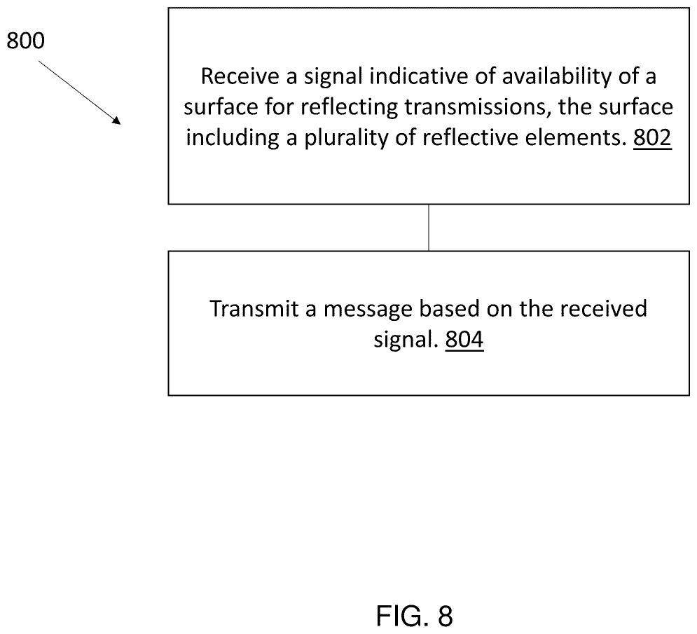

FIG. 8 shows a flowchart of an example method 800 for wireless communication. At 802, a signal indicative of availability of a surface for reflecting transmissions is received, the surface including a plurality of reflective elements. At 804, a message is transmitted based on the received signal. In some embodiments, the message can be transmitted from a network device or a wireless device, including a BS or UE.

In some embodiments, the surface comprising a plurality of reflective elements can be a RIS. The surface and the reflective elements can be configured by a controller coupled to the surface. The controller can be configured by signaling from a network, such as from a BS or network node. In some embodiments, the surface can comprise a rectangular array. The surface can also comprise a non-rectangular array. In some embodiments, subsets of the reflective elements can comprise contiguous elements. Subsets of the reflective elements can also comprise non-contiguous elements.

In some embodiments, the method 800 can further include transmitting a request for availability of a specified subset of the plurality of reflective elements, wherein the signal includes at least one of: an indication the specified subset is available; an indication the specified subset is unavailable; or the indication the specified subset is unavailable and a suggested available subset. In some embodiments, the request can indicate a size of the specified subset or a coordinate of the specified subset.

In some embodiments, the signal at step 802 can indicate a subset of the plurality of reflective elements is available. The message transmitted at 804 can reflected off the subset of the plurality of reflective elements. The signal can include at least one of: an indication of a time a change in availability is applied; a coefficient matrix; or transmission or receiving parameters associated with the configuration. Alternatively or additionally, the signal can include at least one of: a number of available subsets of the plurality of reflective elements; a status of an available subset of the plurality of reflective elements; coordinates of the available subset; scheduling information of the available subset; or an indication of a purpose associated with the available subset. The purpose associated with the available subset can be one of: facilitating communication; facilitating sensing; facilitating positioning; or emergency use.

In some embodiments, the signal at step 802 can include an indication that a subset of the plurality of reflective elements is unavailable. In this case, the signal can include information identifying a device currently associated with the unavailable subset.

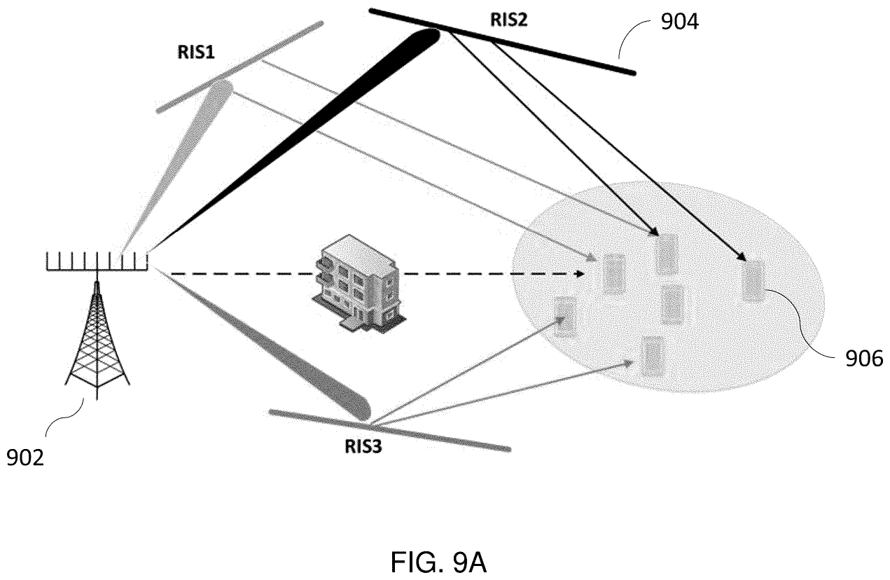

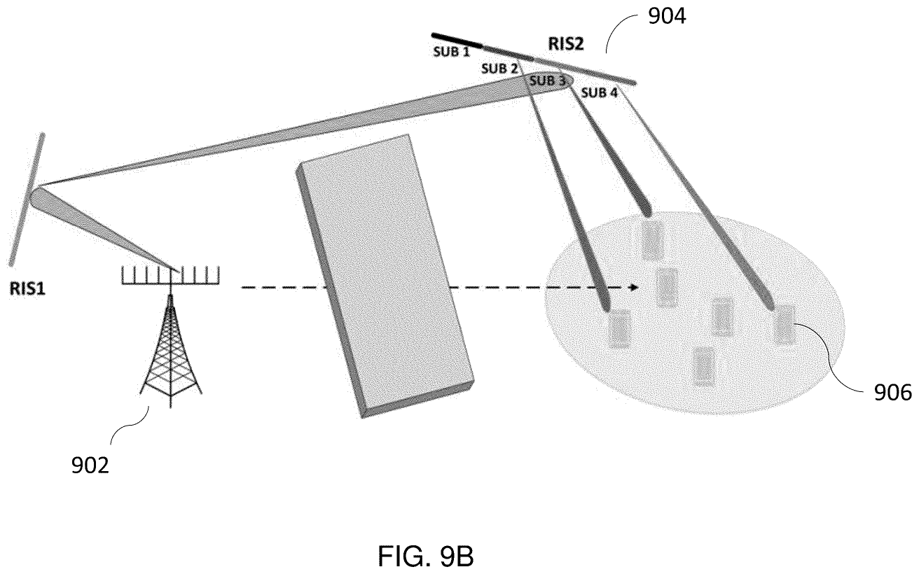

FIGS. 9A-B show examples of wireless communication including a BS 902, a plurality of RISs 904, and a plurality of UEs 906. In some embodiments, there can be a plurality of RISs 904 in a wireless communications environment. Although the previous examples show scenarios depicting a single RIS 904, the disclosed techniques can be similarly performed for multiple RISs 904. For example, the training process described with reference to FIG. 3 can be performed across multiple RISs 904.

As shown in FIG. 9A, an RIS 904 can serve multiple UEs 906, and conversely, a UE 906 can be served by multiple RISs 904. The BS 902 can select optimal or candidate subpanels from multiple RISs 904 using the training process. In general, the BS 902 can select candidate subpanels in any combination across the multiple RISs 904. For example, the BS 902 can select at least one candidate subpanel from each RIS 904, multiple subpanels from an RIS 904, or no subpanels from an RIS 904. Similarly, each of the UEs 906 can select candidate subpanels in any combination from the RISs 904. For example, a UE 902 can select subpanels corresponding to received reference signals reflected from any of the subpanels of RISs 904. Furthermore, each of the plurality of RISs 904 include a controller (not pictured) that can be configured to transmit and receive control signals to and from the BS 902 and UEs 906 in a similar manner to that described with reference to FIG. 6.

As shown in FIG. 9B, transmissions between the BS 902, RISs 904, and UEs 906 can be reflected off multiple RISs 904. In addition, the RISs 904 can have different configuration of subpanels. A BS 902 or UE 906 can select subpanels of an RIS 904 even if there is no direct transmission between the BS/RIS or UE/RIS. For example, the BS 902 in FIG. 9B can select from the subpanels of RIS 2 based on the direction of transmissions to and from RIS 1, or based on control signaling from a RIS controller indicating specific subpanels.

Some embodiments may preferably incorporate the following solutions as described herein.

For example, the solutions listed below may be used by network device implementations as described herein:
1. A method (e.g., method 400 of FIG. 4) of wireless communication, comprising: transmitting, from a network device (e.g., BS 302 of FIG. 3), a first signal (e.g., signal 310 of FIG. 3) to a subset of reflective elements of a surface comprising a plurality of reflective elements (e.g., RIS 304 of FIG. 3), the first signal being reflected off the surface in at least a first direction toward a wireless device; and receiving, from the wireless device, a second signal (e.g., signal 312 of FIG. 3) based on the first signal.
2. The method of solution 1, wherein the first signal is further reflected off the surface in a second direction toward a second wireless device.
3. The method of any of the preceding solutions, wherein the received second signal is reflected off the surface toward the network device.
4. The method of any of the preceding solutions, wherein the first signal includes a reference signal, and wherein the second signal includes a measurement result of the reference signal.
5. The method of any of the preceding solutions, further comprising: modifying a configuration of the network device based on the second signal.
6. The method of solution 5, wherein said modifying the configuration includes: selecting a second subset of reflective elements for transmission.
7. The method of solution 5 or 6, wherein the first signal is associated with a beam, and said modifying the configuration includes: modifying the beam or selecting a different beam for transmission.
8. The method of any of solutions 5-7, wherein said modifying the configuration includes: configuring a direct transmission to the wireless device.
9. The method of any of the proceeding solutions, further comprising: transmitting a third signal (e.g., signal 314 of FIG. 3) to a second subset of the reflective elements of the surface, the third signal being reflected off the surface in at least a second direction toward the wireless device; receiving a fourth signal (e.g., signal 316 of FIG. 3) from the wireless device; and modifying a configuration of the network device based on the second signal and the fourth signal.
10. The method of solution 9, wherein said modifying the configuration includes: selecting the first subset of reflective elements or the second subset of reflective elements for transmission based on measurement results included in the second and fourth signals.

For example, the solutions listed below may be used by wireless device implementations as described herein:
11. A method (e.g., method 500 of FIG. 5) of wireless communication, comprising: receiving, at a wireless device (e.g., UE 306 of FIG. 3), a first signal (e.g., signal 310 of FIG. 3) in a first direction, wherein the first signal is reflected off a subset of reflective elements of a surface (e.g., RIS 304 of FIG. 3) comprising a plurality of reflective elements; and transmitting a second signal (e.g., signal 312 of FIG. 3) to a network device (e.g., BS 302 of FIG. 3) or the surface based on the first signal.
12. The method of solution 11, wherein the second signal is reflected off the surface toward the network device.
13. The method of solution 11 or 12, wherein the first signal is further reflected off the surface in a second direction toward a second wireless device.
14. The method of any of solutions 11-13, wherein the first signal includes a reference signal, the method further comprising: performing a measurement of the reference signal, wherein the second signal includes a result of the measurement.
15. The method of solution 11-14, further comprising: modifying a configuration of the wireless device based on the first signal.
16. The method of solution 15, wherein said modifying the configuration includes: selecting a second direction for receiving signals.
17. The method of solution 15 or 16, wherein the first signal is associated with a first beam, and modifying the configuration includes: selecting a second beam for receiving signals.
18. The method of any of solutions 15-17, wherein modifying the configuration includes: configuring a direct transmission to the network device.
19. The method of any of solutions 11-18, further comprising: receiving, at the wireless device, a third signal (e.g., signal 314 of FIG. 3) in a second direction, wherein the third signal is at least partially reflected off a second subset of reflective elements of the surface; and transmitting a fourth signal (e.g., signal 316 of FIG. 3) from the wireless device.
20. The method of solution 19, further comprising: modifying a configuration of the wireless device based on the first signal and the third signal.
21. The method of solution 20, wherein said modifying the configuration includes: selecting the first direction or the second direction for receiving signals based on a measurement of the first signal and a measurement of the third signal.
22. The method of any of the preceding solutions, wherein the plurality of reflective elements are configured by a controller coupled to the surface.
23. The method of solution 22, wherein the controller is configured via signaling from a base station (BS) or a network node.
24. The method of any of the preceding solutions, wherein the surface comprises a rectangular array of n by m reflective elements, where n and m are positive integers.
25. The method of any of the preceding solutions, wherein the subset of the reflective elements are contiguous.

For example, the solutions listed below may be used for control signaling as described herein (e.g., as performed by controller 608 of FIG. 6):
26. A method (e.g., method 700 of FIG. 7) of wireless communication, comprising: transmitting a signal indicative of availability of a surface (e.g., RIS 604 of FIG. 6) for reflecting transmissions, the surface including a plurality of reflective elements.
27. The method of solution 26, further comprising: receiving a request for availability of a specified subset of the plurality of reflective elements, wherein the signal includes at least one of: an indication the specified subset is available; an indication the specified subset is unavailable; or the indication the specified subset is unavailable and a suggested available subset.
28. The method of solution 26 or 27, wherein the signal indicates a subset of the plurality of reflective elements is available, the method further comprising: reflecting a message off the subset of the plurality of reflective elements.

For example, the following solutions may be used by wireless device or network device implementations as described herein:
29. A method (e.g., method 800 of FIG. 8) of wireless communication, comprising: receiving a signal indicative of availability of a surface (e.g., RIS 604 of FIG. 6) for reflecting transmissions, the surface including a plurality of reflective elements; and transmitting a message based on the received signal.
30. The method of solution 29, further comprising: transmitting a request for availability of a specified subset of the plurality of reflective elements, wherein the signal includes at least one of: an indication the specified subset is available; an indication the specified subset is unavailable; or the indication the specified subset is unavailable and a suggested available subset.
31. The method of solution 29 or 30, wherein the signal indicates a subset of the plurality of reflective elements is available, and wherein the message is reflected off the subset of the plurality of reflective elements.
32. The method of any of solutions 26-30, wherein the signal includes at least one of: an indication of a time a change in availability is applied; a coefficient matrix; or suggested transmission or receiving parameters.
33. The method of any of solutions 26-31, wherein the signal includes at least one of: a number of available subsets of the plurality of reflective elements; a status of an available subset of the plurality of reflective elements; coordinates of the available subset; scheduling information of the available subset; or an indication of a purpose associated with the available subset.
34. The method of solution 33, wherein the purpose associated with the available subset is one of: facilitating communication; facilitating sensing; facilitating positioning; or emergency use.
35. The method of any of solutions 26-34, wherein the signal includes an indication that a subset of the plurality of reflective elements is unavailable.
36. The method of solution 35, wherein the signal further includes information identifying a device currently associated with the unavailable subset.
37. The method of any of solutions 27, 28 or 30-36, wherein the request indicates a size of the specified subset or a coordinate of the specified subset.
38. The method of any of solutions 26-37, wherein the plurality of reflective elements are configured by a controller coupled to the surface.
39. The method of solution 38, wherein the controller is configured via signaling from a base station (BS) or a network node.
40. The method of any of solutions 26-39, wherein the surface comprises a rectangular array of n by m reflective elements, where n and m are positive integers.
41. An apparatus for wireless communication comprising a processor configured to implement the method of any of solutions 1 to 40.
42. A computer readable medium having code stored thereon, the code when executed by a processor, causing the processor to implement a method recited in any of solutions 1 to 40.

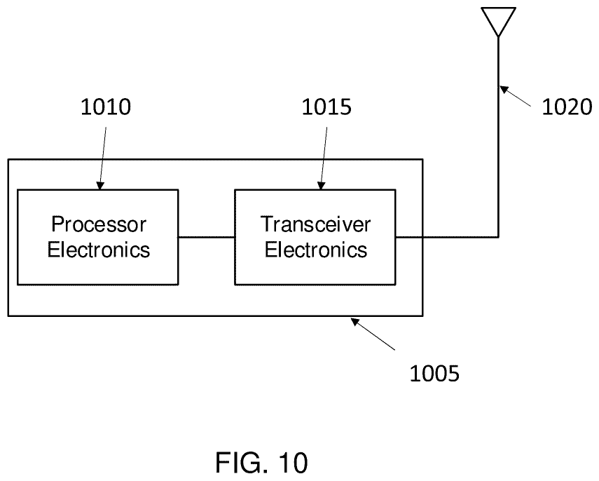

FIG. 10 is a block diagram representation of a portion of an apparatus, in accordance with some embodiments of the presently disclosed technology. An apparatus 1005 such as a network device, a base station, a wireless device (or UE), or a RIS controller can include processor electronics 1010 such as a microprocessor that implements one or more of the techniques presented in this document. The apparatus 1005 can include transceiver electronics 1015 to send and/or receive wireless signals over one or more communication interfaces such as antenna(s) 1020. The apparatus 1005 can include other communication interfaces for transmitting and receiving data. In some embodiments, the apparatus may not include an antenna and rely on wired transmissions, such as for certain implementations of RIS controllers. Apparatus 1005 can include one or more memories (not explicitly shown) configured to store information such as data and/or instructions. In some implementations, the processor electronics 1010 can include at least a portion of the transceiver electronics 1015. In some embodiments, at least some of the disclosed techniques, modules or functions are implemented using the apparatus 1005.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
transmitting, from a network device, a first signal to a subset of reflective elements of a surface comprising a plurality of reflective elements, the first signal being reflected off the surface in at least a first direction toward a wireless device; and
receiving, from the wireless device, a second signal based on the first signal.

2. The method of claim 1, wherein the first signal is further reflected off the surface in a second direction toward a second wireless device.

3. The method of claim 1, wherein the received second signal is reflected off the surface toward the network device.

4. The method of claim 1, wherein the first signal includes a reference signal, and wherein the second signal includes a measurement result of the reference signal.

5. The method of claim 1, further comprising:
modifying a configuration of the network device based on the second signal.

6. The method of claim 5, wherein said modifying the configuration includes:
selecting a second subset of reflective elements for transmission;
and/or, wherein the first signal is associated with a beam, and said modifying the configuration includes: modifying the beam or selecting a different beam for transmission;
and/or, wherein said modifying the configuration includes:
configuring a direct transmission to the wireless device.

7. (canceled)

8. (canceled)

9. The method of claim 1, further comprising:
transmitting a third signal to a second subset of the reflective elements of the surface, the third signal being reflected off the surface in at least a second direction toward the wireless device;
receiving a fourth signal from the wireless device; and
modifying a configuration of the network device based on the second signal and the fourth signal.

10. The method of claim 9, wherein said modifying the configuration includes:
selecting the first subset of reflective elements or the second subset of reflective elements for transmission based on measurement results included in the second and fourth signals.

11. A method of wireless communication, comprising:
receiving, at a wireless device, a first signal in a first direction, wherein the first signal is reflected off a subset of reflective elements of a surface comprising a plurality of reflective elements; and
transmitting a second signal to a network device or the surface based on the first signal.

12. The method of claim 11, wherein the second signal is reflected off the surface toward the network device;
and/or, wherein the first signal is further reflected off the surface in a second direction toward a second wireless device.
and/or, wherein the first signal includes a reference signal, the method further comprising:
performing a measurement of the reference signal,
wherein the second signal includes a result of the measurement.

13. (canceled)

14. (canceled)

15. The method of claim 11, further comprising:
modifying a configuration of the wireless device based on the first signal.

16. The method of claim 15, wherein said modifying the configuration includes:
selecting a second direction for receiving signals;
and/or, wherein the first signal is associated with a first beam, and modifying the configuration includes:
selecting a second beam for receiving signals;
and/or, wherein modifying the configuration includes:
configuring a direct transmission to the network device.

17. (canceled)

18. (canceled)

19. The method of claim 11, further comprising:
receiving, at the wireless device, a third signal in a second direction, wherein the third signal is at least partially reflected off a second subset of reflective elements of the surface; and
transmitting a fourth signal from the wireless device.

20. The method of claim 19, further comprising:
modifying a configuration of the wireless device based on the first signal and the third signal.

21. The method of claim 20, wherein said modifying the configuration includes:
selecting the first direction or the second direction for receiving signals based on a measurement of the first signal and a measurement of the third signal.

22. The method of claim 1, wherein the plurality of reflective elements are configured by a controller coupled to the surface.

23. The method of claim 22, wherein the controller is configured via signaling from a base station (BS) or a network node.

24. The method of claim 1, wherein the surface comprises a rectangular array of n by m reflective elements, where n and m are positive integers;
and/or, wherein the subset of the reflective elements are contiguous.

25. (canceled)

26-40. (canceled)

41. An apparatus for wireless communication comprising a processor configured to implement the method of claim 1.

42. A non-transitory computer readable medium having code stored thereon, the code when executed by a processor, causing the processor to implement a method as claimed in claim 1.
